(19) United States
(12) Patent Application Publication
(10) Pub. No.: US 2009/0247347 A1
(43) Pub. Date: Oct. 1, 2009

(54) LUBRICATING DEVICE FOR PINION GEAR IN PLANETARY GEAR SET

(75) Inventor: Youngsam CHOI, Seoul (KR)

Correspondence Address: MORGAN, LEWIS & BOCKIUS LLP (SF), One Market, Spear Street Tower, Suite 2800, San Francisco, CA, 94105, US

(73) Assignee: Hyundai Motor Company, Seoul (KR)

(21) Appl. No.: 12/267,387

(22) Filed: Nov. 7, 2008

(30) Foreign Application Priority Data
Apr. 1, 2008 (KR) 10-2008-0030171

(51) Int. Cl. F16H 57/04

(52) U.S. Cl. 475/159

(57) ABSTRACT

A lubricating device for a pinion gear in a planetary gear set provides smooth lubrication between a pinion shaft and a pinion bearing, and prevents scuffing due to lack of lubrication between the pinion shaft and a pinion gear. Oil may be supplied into a hollow of the pinion shaft while maintaining a level of lubrication pressure while the oil is discharged from an oil jet hole of a rotary shaft. The lubricating device may include an oil guide for supplying oil to a hollow of a pinion shaft supporting the pinion gear, the oil guide including a main body disposed about a rotary shaft and a closed outer circumference, the main body and outer circumference defining an oil-storage space in fluid communication with an oil jet hole of the rotary shaft, and/or a sub-body extending from the main body into the hollow of the pinion shaft and having an inner passage fluidly communicated with the oil-storage space.

### CROSS-REFERENCE TO RELATED APPLICATION

The present application claims priority to Korean Application Number 10-2008-0030171 filed Apr. 1, 2008, the entire contents of which is incorporated herein for all purposes by this reference.

### BACKGROUND OF THE INVENTION

1. Field of the Invention

The present invention relates to a lubricating device for a pinion gear in a planetary gear set, particularly a lubricating device for a pinion gear in a planetary gear that allows smooth lubrication between a pinion shaft and a needle bearing by effectively flowing oil discharged from a rotary shaft into a hollow of the pinion shaft.

2. Description of Related Art

In general, an automatic transmission, having a function of transmitting a driving force of the engine to the driving wheel, transmits a driving force generated by the engine to the driving wheels while automatically changing the speed ratio, using a plurality of friction elements therein, including a planetary gear set, a clutch, and a brake.

In the related art, a planetary gear set, as shown in FIGS. 1 to 3, includes a sun gear 12 fitted on a rotary shaft 10, a plurality of pinion gears 14 engaged with the outer circumference of sun gear 12, a ring gear 16 of which the inner circumference is engaged with outer circumferences of pinion gears 14, and a carrier connecting pinion gears 14.

In the above configuration, pinion gear 14 is supported by a needle bearing 18 on a pinion shaft 20 and pinion shaft 20 is fixed to the carrier such that the position of pinion gear 14 with respect to the carrier is fixed.

Furthermore, pinion shaft 20 is provided with an oil guide 22 for lubrication between pinion shaft 20 and needle bearing 18 and oil guide 22 has a ring-shaped side wall 22a that extends in the radial direction of rotary shaft 10 and a plurality of insertions 22b that protrudes from outer circumference of side wall 22a in the axial direction of rotary shaft 10 and is inserted in an hollow 20a of pinion shaft 20, in which insertions 22b are integrally formed with side wall 22a. Insertions 22b are disposed at predetermined distance from the center of side wall 22a in a radial direction thereof and circumferentially spaced apart from each other.

The cross section of insertion 22b is a semi-arc shape with the inner circumference recessed and insertion 22b is positioned outside the location radius R of pinion shaft 20, in hollow 20a of pinion shaft 20. The location radius R of pinion shaft 20 is, as shown in FIG. 4, the distance from the axial center CL of rotary shaft 10 to the axial center CL′ of pinion shaft 20.

Therefore, oil that is discharged from an oil jet hole 10a formed through rotary shaft 10 is radially dispersed from axial center CL of rotary shaft 10 by a centrifugal force and the oil that is dispersed is guided by side wall 22a of oil guide 22 and flows into hollow 20a of pinion shaft 20 through insertion 22b.

Furthermore, an oil flow hole 20b that is fluid-communicated with hollow 20a is formed toward needle bearing 18 in pinion shaft 20, such that the oil that flows in hollow 20a is supplied to needle bearing 18 through oil flow hole 20b to achieve smooth lubrication between needle bearing 18 and pinion shaft 20.

However, the oil supplied to rotary shaft 10 is under a predetermined pressure for lubrication, that is, the lubrication pressure of the oil is higher than the atmospheric pressure, but the oil discharged through oil jet hole 10a of rotary shaft 10 is exposed to the atmospheric pressure in the automatic transmission; therefore, the lubrication pressure of the oil drops to the atmospheric pressure. Accordingly, the lubricating oil that has flowed in hollow 20a of pinion shaft 20 along oil guide 22 is supplied, under only the pressure by the centrifugal force, to needle bearing 18 through oil flow hole 20b of pinion shaft 20.

As a result, as shown in FIG. 4, because oil flow hole 20b have to be positioned only outside the location radius R in hollow 20a of pinion shaft 20, it is impossible to directly supply the oil to rolling contact portion between needle bearing 18 and pinion shaft 20 that is positioned inside the location radius R.

In other words, the above configuration has a problem in that it is impossible to directly supply the oil to the section between 5 o'clock and 7 o'clock points of needle bearing 18 from axial center CL′ of pinion shaft 20, i.e. the portion of the rolling contact section where lubrication is most difficult.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a lubricating device for a pinion gear in a planetary gear set that provides smooth lubrication between a pinion shaft and a needle bearing and prevent scuffing due to lack of lubrication between the pinion shaft and a pinion gear, by supplying oil into a hollow of the pinion shaft while keeping the level of lubrication pressure of the oil when the oil is discharged from an oil jet hole of a rotary shaft.

One aspect of the present invention is directed to a lubricating device for a pinion gear in a planetary gear set. The lubricating device may include an oil guide for supplying oil to a hollow of a pinion shaft supporting the pinion gear, the oil guide including a main body disposed about a rotary shaft and a closed outer circumference, the main body and outer circumference defining an oil-storage space in fluid communication with an oil jet hole of the rotary shaft, and/or a sub-body extending from the main body into the hollow of the pinion shaft and having an inner passage fluidly communicated with the oil-storage space.

The main body may include an open inner circumference allowing fluid communication between the oil jet hole and the oil-storage space, and may be in close contact with an outer circumference of the rotary shaft. The storage space may be defined by the main body and the outer circumference of the rotary shaft. An outer diameter of the sub-body may be substantially the same as an inner diameter of the hollow of the pinion shaft.

The lubricating device may further include a plurality of sub-bodies extending from the main body into a respective hollow of a plurality of pinion shafts. The sub-bodies may be disposed at a predetermined distance from the center of the main body and circumferentially spaced apart from each other.

The main body and outer circumference may be monolithically formed. The main body, outer circumference, and sub-body may be monolithically formed. The sub-body may be cylindrically shaped.

The pinion shaft may include an oil-flow hole that may be in fluid-communication with the inner passage of the sub-body through the hollow to supply the oil to a bearing rotatably mounting the pinion gear on the pinion shaft.

Another aspect of the present invention is directed to an engine of a passenger vehicle. The engine may include any of the above-mentioned lubricating devices.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a cross-sectional view illustrating a lubricating structure for a planetary gear set and a pinion gear in the related art.

FIG. 2 is a right side view of FIG. 1.

FIG. 3 is a perspective view of the oil guide shown in FIGS. 1 and 2.

FIG. 4 is a view illustrating the position of an oil flow hole of the pinion shaft shown in FIG. 2.

FIG. 5 is a cross-sectional view illustrating an exemplary lubricating structure for a pinion gear in a planetary gear according to an aspect of the invention.

FIG. 6 is a right side view of FIG. 5.

FIG. 7 is a perspective view of the oil guide shown in FIGS. 5 and 6.

FIG. 8 is a perspective view showing the cross section of the oil guide shown in FIG. 7, taken along the line VIII-VIII.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

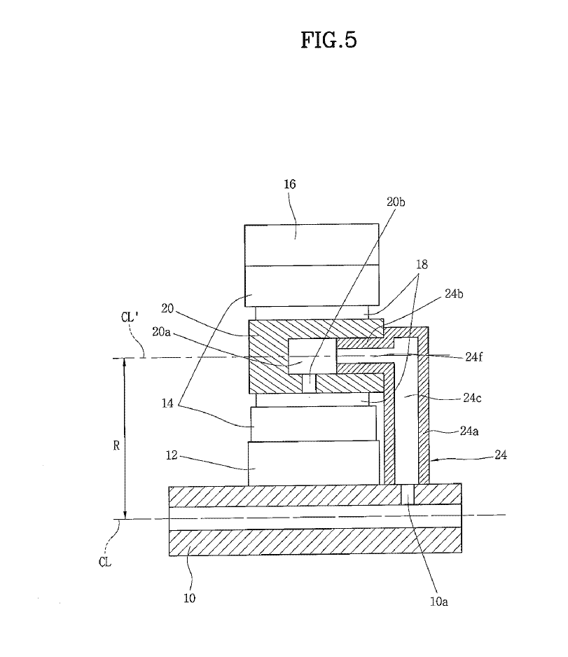

As shown in the FIG. 5, a planetary gear set equipped in an automatic transmission includes a sun gear 12 fitted on a rotary shaft 10, a plurality of pinion gears 14 engaged with the outer circumference of sun gear 12, a ring gear 16 of which the inner circumference is engaged with outer circumferences of pinion gears 14, and a carrier connecting pinion gears 14. Pinion gear 14 is supported by a needle bearing 18 on a pinion shaft 20 and pinion shaft 20 is fixed to the carrier such that the position of pinion gear 14 with respect to the carrier is fixed. That is, needle bearing 18 is fitted on the outer circumference of pinion shaft 20 and the inner circumference of pinion gear 14 is supported by the outer circumference of needle bearing 18.

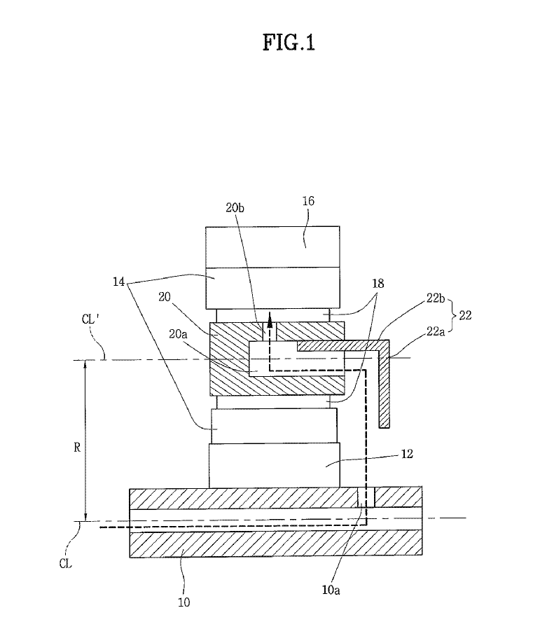

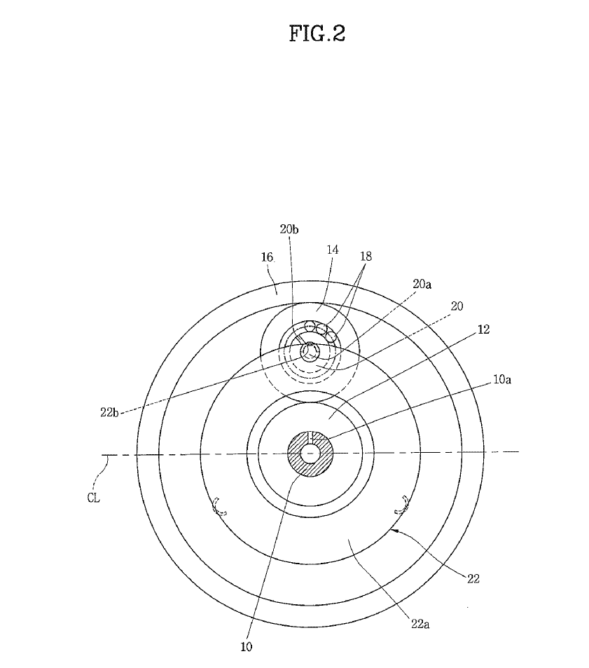

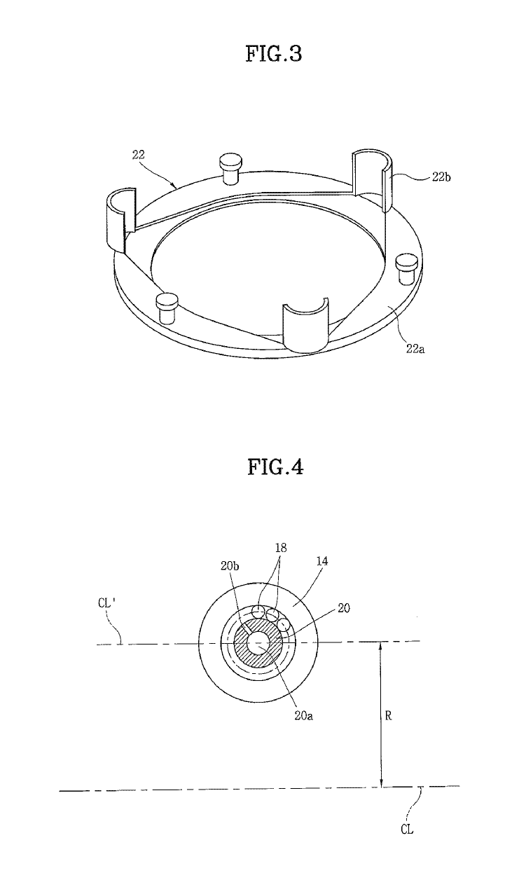

Furthermore, pinion shaft 20 is provided with an oil guide 24 for lubrication between pinion shaft 20 and needle bearing 18, but oil guide 24 has a structure different from that of oil guide 22 in the related art, shown in FIGS. 1 to 3.

That is, oil guide 24 of the present invention has a ring-shaped main body 24a is fluid-communicated airtight with an oil jet hole 10a formed in rotary shaft 10 and cylindrical sub-bodies 24b that protrude from main body 24a in the axial direction of rotary shaft 10 and are inserted in an hollow 20a of pinion shaft 20.

Main body 24a has an oil storage space 24c that is formed around rotary shaft 10 to store oil and the inner circumference 24d that is open such that oil store space 24c is fluid-communicated with oil jet hole 10a, and an outer circumference 24e that is closed to prevent leakage of oil that has flowed in oil store space 24c.

Furthermore, oil store space 24c formed in main body 24a is radially formed around the entire circumference of rotary shaft 10 and inner circumference 24d is in close contact with the entire outer circumference of rotary shaft 10 to prevent the pressure in oil store space 24c from being released outside.

Sub-body 24b has an inner passage 24f formed in the axial direction of rotary shaft 10 to be fluid-communicated with oil store space 24c and the outer diameter of sub-body 24b is set to be the same as the inner diameter of hollow 20a of pinion shaft 20 such that sub-body 24b is fitted tight in hollow 20a of pinion shaft 20.

Sub-bodies 24b are disposed at a predetermined distance from the center of main body 24a and circumferentially spaced apart from each other, in which the sub-bodies 24b are displaced along a rotation center of the pinion gears 14 engaged with the outer circumference of sun gear 12.

Therefore, the lubrication pressure of oil discharged through oil jet hole 10a of rotary shaft 10 can be kept high throughout the oil supply passage formed from oil jet hole 10a of rotary shaft 10 to hollow 20a of pinion shaft 20 through oil store space 24c of main body 24a and inner passage 24f of sub-bodies 24b.

That is, unlike the structures in the related art, since the oil supply passage from oil jet hole 10a of rotary shaft 10 to hollow 20a of pinion shaft 20 is kept airtight (the internal lubrication pressure of the oil is not released to the outside that is under the atmospheric pressure), the lubrication pressure of the oil supplied through rotary shaft 10 can be transmitted, without changing, to hollow 20a of pinion shaft 20 through oil guide 24. Therefore, smooth lubrication is possible between pinion gear 14, needle bearing 18, and pinion shaft 20.

Furthermore, because it is possible to position oil flow hole 20b of pinion shaft 20 inside the location radius R of pinion shaft 20, it is possible to directly supply the oil to the section between the 3 o'clock and 9 o'clock points, particularly the 5 o'clock and 7 o'clock points of needle bearing 18 from the axial center CL′ of pinion shaft 20. This is possible because the lubrication pressure of the oil that has been supplied from oil jet hole 10a of rotary shaft 10 to hollow 20a of pinion shaft 20 through oil guide 24 can be maintained at the initial high level when the oil passes through oil jet hole 10a.

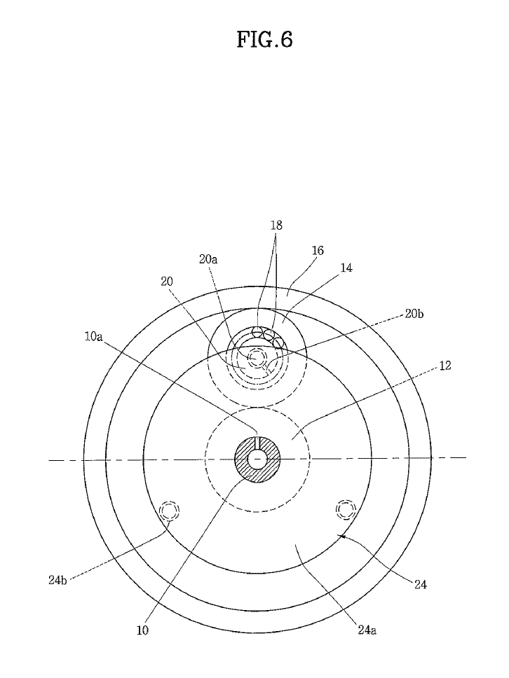

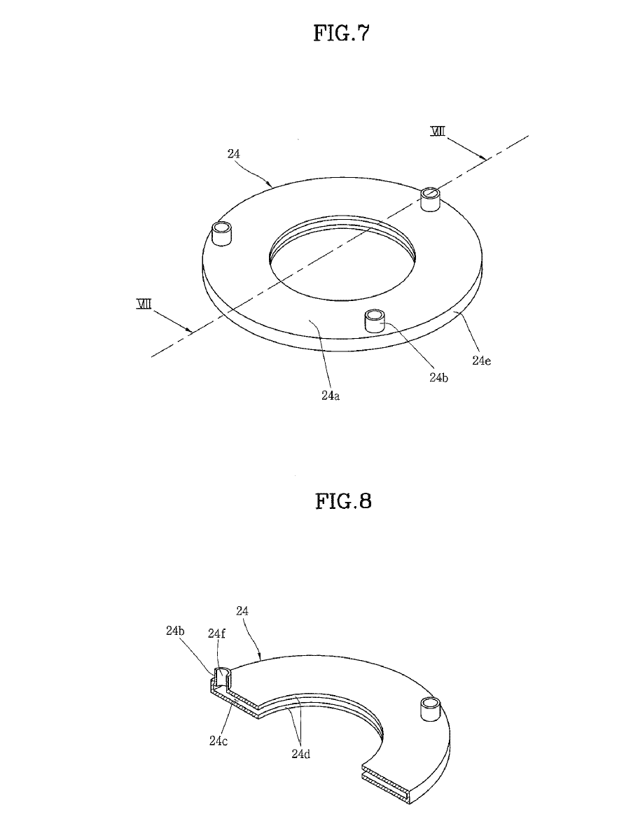

Furthermore, even if oil flow hole 20b of pinion shaft 20 is formed at any position inside and/or outside the location radius R of pinion shaft 20, the oil can be supplied to the rolling contact portion between needle bearing 18 and pinion shaft 20 while keeping the lubrication pressure at oil jet hole 10a of rotary shaft 10. Accordingly, as shown in FIGS. 5 and 6, oil flow hole 20b can be positioned inside the location radius R or outside the location radius R from the axial center CL′ of pinion shaft 20, or both inside and outside the location radius R.

According to the lubricating device for a pinion gear in a planetary gear of the invention, it is possible to achieve uniform and smooth lubrication for the entire portion between the pinion gear and the needle bearing, because it is possible to supply oil, which has been discharged from the oil jet hole formed through the rotary shaft of an automatic transmission to the pinion gear, to the hollow of the pinion shaft while keeping the lubrication pressure.

As a result, according to various embodiments of the invention, sufficient lubrication is possible between pinion gears 14, needle bearings 18, and pinion shafts 20 in the planetary gear set, such that it is possible to solve the problem in the related art, such as scuffing of pinion gears 14 due to lack of lubrication and deterioration of durability. In other words, it is possible to prevent scuffing due to lack of lubrication between the pinion shaft and the pinion gear and solve the problem, such as deterioration of durability of the planetary gear set due to scuffing at the contact portion.

For convenience in explanation and accurate definition in the appended claims, the terms “right”, “outside”, “inside”, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A lubricating device for a pinion gear in a planetary gear set, the lubricating device comprising:
an oil guide for supplying oil to a hollow of a pinion shaft supporting the pinion gear,
the oil guide including a main body disposed about a rotary shaft and a closed outer circumference, the main body and outer circumference defining an oil-storage space in fluid communication with an oil jet hole of the rotary shaft, and
a sub-body extending from the main body into the hollow of the pinion shaft and having an inner passage fluidly communicated with the oil-storage space.

2. The lubricating device as defined in claim 1, wherein the main body includes an open inner circumference allowing fluid communication between the oil jet hole and the oil-storage space, and is in close contact with an outer circumference of the rotary shaft.

3. The lubricating device as defined in claim 2, wherein the oil storage space is defined by the main body and the outer circumference of the rotary shaft.

4. The lubricating device as defined in claim 1, wherein an outer diameter of the sub-body is substantially the same as an inner diameter of the hollow of the pinion shaft.

5. The lubricating device as defined in claim 1, comprising a plurality of sub-bodies extending from the main body into a respective hollow of a plurality of pinion shafts.

6. The lubricating device as defined in claim 5, wherein the sub-bodies are disposed at a predetermined distance from the center of the main body and circumferentially spaced apart from each other.

7. The lubricating device as defined in claim 1, wherein the main body and outer circumference are monolithically formed.

8. The lubricating device as defined in claim 1, wherein the main body, outer circumference, and sub-body are monolithically formed.

9. The lubricating device as defined in claim 1, wherein the sub-body is cylindrically shaped.

10. The lubricating device as defined in claim 1, wherein the pinion shaft includes an oil-flow hole that is in fluid-communication with the inner passage of the sub-body through the hollow to supply the oil to a bearing rotatably mounting the pinion gear on the pinion shaft.

11. An engine of a passenger vehicle, the engine comprising the lubricating device as defined in claim 1.
